(19) United States
(12) Patent Application Publication
(10) Pub. No.: US 2024/0378478 A1
(43) Pub. Date: Nov. 14, 2024

(54) Compiler for Quantum Computing

(71) Applicant: Northeastern University, Boston, MA (US)

(72) Inventors: Tirthak Lalitbhai PATEL, Boston, MA (US); Devesh TIWARI, Boston, MA (US)

(21) Appl. No.: 18/318,409

(22) Filed: May 16, 2023

Related U.S. Application Data
(60) Provisional application No. 63/364,732, filed on May 16, 2022.

(51) Int. Cl. G06N 10/40

(52) U.S. Cl. CPC G06N 10/40

(57) ABSTRACT

In embodiments, a method includes the following operations. For each qubit gate of a quantum circuit within a qubit frontier of a circuit operation of qubit gates of the circuit, the method (a) determines a set of three-or-more-qubit blocks from the qubit frontier to an interior of the circuit, (b) determines a number of operations of a subset of blocks in the set of three-or-more-qubit blocks, (c) determines a family of blocks with a highest number of operations, (d) for each respective three-or-more-qubit block of the set, determines a block family with a highest number of available operations that starts with the respective three-or-more-qubit block and adheres to restriction zones of the blocks, and (e) adds a three-or-more-qubit block having a highest number of operations to a blocked circuit. Each qubit gate is a one-or-two-qubit gate of fewer bits than a number of bits of the three-or-more-qubit blocks.

### RELATED APPLICATION

This application claims the benefit of U.S. Provisional Application No. 63/364,732, filed on May 16, 2022. The entire teachings of the above application are incorporated herein by reference.

### BACKGROUND

Qubits and Quantum States. The state of a qubit (short for “quantum bit”) is best represented in Dirac notation: Ψ=α0+β1. Here, Ψ∈ [symbol] ² defines the state of a qubit; where a qubit exists in a superposition of the two basis states:

$$0 = [ \begin{matrix}1 \\ 0\end{matrix} ]$$

$$and$$

$$1 = [ \begin{matrix}0 \\ 1\end{matrix} ] .$$

α∈ [symbol] and β∈ [symbol] are complex-valued coefficients that represent the amplitude and phase contribution of their respective basis states to the qubit state Ψ. These coefficients must satisfy α²+β²=1. The unit vector space spanning all possible superpositions construct what is known as a Hilbert Space. In general, an n-qubit state can be represented by Ψ∈ [symbol] ²^{ⁿ} under this Dirac notation.

Quantum Operations. Desired qubit superpositions are achieved using unitary transformations known as quantum operations or gates. These unitary transformations can be represented as 2ⁿ×2ⁿ-dimensional unitary matrices (applied to 2ⁿ-dimensional vectors). The following is a general three-parameter rotational gate, U3, which can put a qubit in any desired superposition by controlling the angle parameters.

$$U 3 ( θ , ϕ , λ ) = [ \begin{matrix}cos ( \frac{θ}{2} ) & - {e}^{i λ} sin ( \frac{θ}{2} ) \\ {e}^{i ϕ} sin ( \frac{θ}{2} ) - 2 & {e}^{i ( ϕ + λ )} cos ( \frac{θ}{2} )\end{matrix} ]$$

Here, θ, ϕ, λ∈[0,2π] are angle parameters that determine the gate that is applied to the qubit. The commonly-used Hadamard or

$$H = \frac{1}{\sqrt{2}} [ \begin{matrix}1 & 1 \\ 1 & - 1\end{matrix} ]$$

gate is realized as

$$U 3 ( \frac{π}{2} , 0 , π ) ,$$

while the Identity or

$$I = [ \begin{matrix}1 & 0 \\ 0 & 1\end{matrix} ]$$

gate is U3 (0, 0, 0).

Multi-qubit gates entangle two or more qubits. For example, the CZ and CX (also known as CNOT) gates are widely used two-qubit gates. In such a two-qubit gate, one qubit serves as the control qubit and the other as the target, with the operation being applied to the target qubit depending on the state of the control qubit.

A CZ gate can be represented as following:

$$CZ = [ \begin{matrix}1 & 0 & 0 & 0 \\ 0 & 1 & 0 & 0 \\ 0 & 0 & 1 & 0 \\ 0 & 0 & 0 & - 1\end{matrix} ] , CX ( I ) CZ ( I )$$

### SUMMARY

In some embodiments, a method and/or corresponding system of converting a one-bit or two-qubit quantum circuit to a three-or-more-qubit quantum circuit includes the following operations. For each qubit gate of a plurality of qubit gates of a quantum circuit within a qubit frontier of a circuit operation of one or more qubit gates of the circuit, the method (a) determines a set of three-or-more-qubit blocks from the qubit frontier to an interior of the circuit, (b) determines a number of operations of at least a subset of blocks in the set of three-or-more-qubit blocks, (c) determines a family of blocks with a highest number of operations, (d) for each respective three-qubit block of the set of three-or-more-qubit blocks, determines a block family with a highest number of available operations that starts with the respective three-or-more-qubit block and adheres to restriction zones of the blocks, and (e) adds a three-or-more-qubit block having a highest number of operations to a blocked circuit. Each of the plurality of qubit gates is a one-bit or two-bit qubit gate of fewer bits than a number of bits of the three-or-more-qubit blocks.

In some embodiments, the blocked circuit is a first blocked circuit, and the method further includes repeating the operations above to create a second blocked circuit, the second blocked circuit representing gates of the quantum circuit that is mutually exclusive from gates representing the first blocked circuit.

In some embodiments, the qubit gates are at least one of a neutral atom qubit gate, a superconducting qubit gate, and a photon-based qubit gate.

In some embodiments, the qubits are arranged in a triangular grid.

In some embodiments, the blocked circuit can change over time or for executing different instructions.

In some embodiments, the restriction zones of the blocks are based on qubits being restricted from engaging in quantum operations depending on nearby qubit activity.

In some embodiments, the method further includes (i) based on the blocked quantum circuit comprising a plurality of one-qubit gates and two-qubit gates, determining a parameterized layer of three-qubit gates, (ii) adding the determined parameterized layer to a composed block quantum circuit, (iii) determining whether the distance of the blocked quantum circuit and the composed block quantum circuit is below a particular threshold, (iv)(1) if the distance is below the particular threshold, outputting the composed block quantum circuit, and (iv)(2) if the distance is equal to or above the particular threshold, repeating (i)-(iv).

In some embodiments, the method further includes interfacing with a quantum computer as the computer runs a program, and iterating the operations above for different instructions than the quantum computer is executing.

In some embodiments, the set of three-or-more qubit blocks is a set of three-qubit blocks.

In some embodiments, determining a number of operations of at least a subset of blocks in the set of three-or-more-qubit blocks is determining a number of operations of all blocks in the set of three-or-more-qubit blocks

In some embodiments, method of converting a one-bit or two-qubit quantum circuit to a three-or-more-qubit quantum circuit includes (a) based on an input block quantum circuit comprising a plurality of one-qubit gates and two-qubit gates, determining a parameterized layer of three-or-more-qubit gates, (b) adding the determined parameterized layer to a composed block quantum circuit, (c) determining whether the distance of the input block quantum circuit and the composed block quantum circuit is below a particular threshold, (d)(1) if the distance is below the particular threshold, outputting the composed block quantum circuit, and (d)(2) if the distance is equal to or above the particular threshold, repeating (a)-(d).

In some embodiments, the particular threshold is based on the size of the input block quantum circuit or the size of the composed block quantum circuit.

In some embodiments, the distance is at least one of the Hilbert-Schmidt Distance (HSD) and a total variation distance (TVD).

In some embodiments, step (d)(1) further includes if the distance is below the particular threshold and the size of the composed block quantum circuit is greater than the size of the input block quantum circuit, returning the input block quantum circuit.

In some embodiments, the qubit gates are a neutral atom qubit gate, a superconducting qubit gate, or a photon-based qubit gate.

In some embodiments, determining the parameterized layer further includes determining angles between the three-qubit gates and determining a parameter for the configuration of the three-or-more-qubit gates such that the parameters are optimized to minimize the distance between unitaries of the input block quantum circuit and the composed block quantum circuit.

In some embodiments, the three-or-more-qubit gates are three-qubit gates.

In some embodiments, the parameterized layer includes a plurality of U3 gates and one or more CCZ gate.

In some embodiments, the method further includes determining a block circuit to input for input block quantum circuit by, for each qubit gate of a plurality of qubit gates of a quantum circuit within a qubit frontier of a circuit operation of one or more qubit gates of the quantum circuit: (a) determining a set of three-qubit blocks from the qubit frontier to an interior of the circuit, (b) determining a number of operation of all blocks in the set of three-qubit blocks, (b) determining a family of blocks with a highest number of operations, (c) for each respective three-qubit block of the set of three-qubit blocks, find a best block family that starts with the respective three-qubit block and adheres to restriction zones of the blocks, and (d) adding a three-qubit block having a highest number of operations to an input block quantum circuit. Each of the plurality of qubit gates is a one-bit or two-bit qubit gate.

In some embodiments, the method includes interfacing with a quantum computer as the computer runs a program, and iterating the steps of Claim 1 for different instructions than the quantum computer is executing.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a diagram illustrating an example embodiment of a quantum circuit.

FIG. 2A is a flow diagram illustrating an example embodiment of the method of the present disclosure.

FIG. 2B is a block diagram illustrating an example embodiment of the present disclosure.

FIG. 3A is a diagram illustrating pulse steps corresponding to a Controlled-Z (CZ)gate.

FIG. 3B is a diagram illustrating pulse steps corresponding to a three-qubit gate operation, or controlled controlled-z (CCZ), gate.

FIG. 4 is a diagram illustrating an example embodiment of a snapshot of operation executions at a given moment in time.

FIG. 5 is a block diagram illustrating an example embodiment of blocking a quantum circuit into three blocks.

FIG. 6 is a flow diagram illustrating steps of the present method and corresponding system circuit mapping circuit blocking and block composition.

FIG. 7 is a diagram illustrating three-qubit and four-qubit gates.

FIG. 8 is a diagram illustrating the formation of blocks.

FIG. 9 is a diagram 90 illustrating round-by-round block formation procedure such that block families having the maximum number of operations are formed at any given round.

FIG. 10 is a diagram illustrating an example embodiment of block composition, starting from an original block to a composed block.

FIG. 11 is a diagram illustrating the decomposition of a CCZ gate into a decomposed CCZ gate of one-qubit U3 and two-qubit CZ gates.

FIG. 12 is a graph illustrating the present method and corresponding system (Geyser) reducing the total number of pulses in the circuit compared to the Baseline and OptiMap techniques.

FIG. 13 is a graph illustrating the present method and corresponding system (Geyser) reducing the number of pulses in the critical path of the circuit compared to Baseline and OptiMap.

FIGS. 14A-C are graphs illustrating the number of one-qubit U3, CZ, and CCZ gates with the three techniques, respectively.

FIG. 15 is a graph illustrating the TVD to the ideal output when the circuit is compiled with the Baseline, OptiMap, and Geyser techniques.

FIG. 16 is a diagram illustrating the TVD to the ideal output when the circuit is run on superconducting qubits compared to when it is run on neutral atoms with Geyser.

FIGS. 17A-B are graphs illustrating a TVD to the ideal output when the circuit is compiled with the Baseline, OptiMap, and Geyser techniques for different error rates.

FIGS. 18A-B graphs illustrating TVD to the ideal output when the circuit is run on superconducting qubits compared to when it is run on neutral atoms with Geyser for different error rates.

FIG. 19 illustrates a computer network or similar digital processing environment in which embodiments of the present invention may be implemented.

FIG. 20 is a diagram of an example internal structure of a computer (e.g., client processor/device or server computers) in the computer system of FIG. 19.

### DETAILED DESCRIPTION

A description of example embodiments follows.

Compared to widely-used superconducting qubits, neutral-atom quantum computing technology promises potentially better scalability and flexible arrangement of qubits to allow higher operation parallelism and more relaxed cooling requirements. The high performance computing (HPC) and architecture community is beginning to design new solutions to take advantage of neutral-atom quantum architectures and overcome its unique challenges.

Disclosed herein is a method and corresponding system, referred to as “Geyser,” that is the first work to take advantage of the multi-qubit gates natively supported by neutral-atom quantum computers by appropriately mapping quantum circuits to three-qubit-friendly physical arrangement of qubits. Geyser creates multiple logical blocks in the quantum circuit to exploit quantum parallelism and reduce the number of pulses needed to realize physical gates. These circuit blocks elegantly enable Geyser to compose equivalent circuits with three-qubit gates, even when the original program does not have any multi-qubit gates. Experimental results illustrate that Geyser reduces the number of operation pulses by 25%-90% and improves output fidelity of the quantum circuit by 25%-60% points.

Quantum computing is progressing at a rapid pace, with multiple promising computing technologies maturing toward physical realization at the production level and in research lab settings. Superconducting, neutral atom, trapped-ion, and photonics are among the most promising technologies. Each architecture offers unique advantages over other competing technologies. Multiple technologies and quantuum architecures may be produced in the future to serve different mission needs and local-technological expertise.

Compared to widely-used superconducting qubits, neutral-atom quantum computing technology provides potentially better scalability, flexible arrangement of qubits to allow higher quantum operation parallelism, and more relaxed cooling requirements. Unfortunately, neutral-atom quantum architecture has received limited attention from the HPC and architecture community due to its unique computing model constraints and characteristics. Examples of these constraints include certain qubits being restricted from engaging in quantum operations depending on the neighbor's activity, no physical links being between qubits, Rydberg transitions-driven long-distance qubit interactions, and topological constraints of qubits.

In one current solution, a method designs a solution that maps quantum circuits to a neutral-atom quantum architecture, while respecting the technological constraints including long-term qubit interactions, atom error rates, and qubit engagement restriction constraints. While this current work is useful as a first step, an opportunity specific to neutral-atom architecture remains unexplored: the ability to take advantage of multi-qubit operations natively supported on neutral atom architecture, unlike superconducting-based qubit technology that only supports one- and two-qubit gate operations.

Unfortunately, taking advantage of three-or-more-qubit operations, even when natively supported on the underlying hardware, is challenging because it is non-trivial for quantum programmers to reason about the program functionality and output verification for quantum programs involving three-qubit operations. The present system and corresponding method, Geyser, solves this challenge via a novel compiler that performs a optimization pass that automatically creates three-qubit operations from one-qubit or two-qubit quantum circuit designs to take advantage of neutral atom interactions.

As Geyser's design and implementation demonstrates, it is challenging to create three-qubit operations in a scalable fashion for a given arbitrary quantum circuit. Geyser's method and corresponding is a three-step process.
a) First, Geyser chooses a three-qubit-friendly physical arrangement of qubits and maps the circuit to it.
b) Second, Geyser then intelligently creates multiple blocks (self-contained set of quantum operations) in the quantum circuit. Among these multiple blocks, Geyser chooses these blocks to intelligently strike the balance between maximizing quantum operation parallelism and reduce the physical pulses required to realize the quantum operations. Geyser's design makes a special distinction about focusing on reducing the number of pulses instead of the traditional metric of number of gates, due to involved trade-offs in error-probability and computational parallelism.
c) Third, Geyser demonstrates its ability to create three-qubit operations by operating on the created and chosen/selected smaller blocks of the original circuit, where it can deterministically find the opportunity to create three-qubit gates from a set of one- and two-qubit operations and effectively reason about its impact on improving the overall output fidelity.

In some embodiments, Geyser is a novel framework to improve output fidelity of quantum programs on neutral-atom quantum architectures, by carefully navigating the unique design trade-offs present in neutral-atom quantum technology (e.g., atom connectivity & topology, three-qubit entanglement via Rydberg transitions, and operation restriction zones). In some embodiments, Geyser is implemented as a compiler using a processor and memory to convert quantum programs to have three-qubit operations. In particular, Geyser introduces novel concepts of circuit blocking and circuit composition to improve program output fidelity by reducing the critical depth of quantum circuits and physical pulses required to realize the quantum gates. Geyser is the first work to demonstrate how to opportunistically create multi-qubit operations from a set of one- and two-qubit operations when feasible, to leverage specific advantages that neutral-atom technology offers. Geyser's compilation framework enables quantum programmers to automatically take advantage of neutral-atom architecture and significantly improve their output fidelity, even when their original programs only contain one- or two-qubit operations.

Evaluation of the results of the present system and method show reduction in the number of quantum operation pulses by 25%-90% and improvement over method's output fidelity (e.g., total variation distance) by 25%-60% points across different representative benchmarks over competitive techniques on both neutral-atom and superconducting-qubit architectures. As such, the present system and method improves on previous quantum computing architectures by solving the problem of automatically converting quantum circuits having one- or two-qubit operations or gates to three-qubit gates.

One of the major advantages of neutral-atom based quantum computing is its ability to natively perform three-qubit gates, which is not feasible on superconducting-qubit architectures. Three-qubit gate operations (e.g., CCZ) reduce the number of operations required to accomplish a task and enable more parallelism. A CCZ gate is represented as following:

$$CCZ = [ \begin{matrix}1 & 0 & 0 & 0 & 0 & 0 & 0 & 0 \\ 0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & 1 & 0 \\ 0 & 0 & 0 & 0 & 0 & 0 & 0 & - 1\end{matrix} ]$$

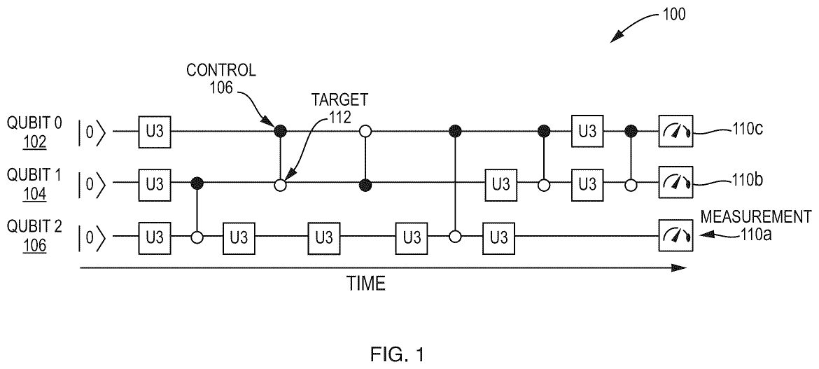

FIG. 1 is a diagram illustrating an example embodiment of a quantum circuit 100. The quantum circuit 100 illustrates components such as qubits 102, 104, 106, gates (labeled with U3), control 108, target 112, and measurements 110. A sequence of quantum gates applied in succession to one another on a system of n-qubits form an n-qubit quantum circuit 100. A quantum circuit 100 can be represented as the unitary matrix U∈ [symbol] ²^{ⁿ}^{×2}^{ⁿ} that represents the overall unitary transformation of an n-dimensional quantum circuit. U can be calculated by taking a Kronecker product (e.g., a tensor product with respect to a standard basis) of all of the quantum gates (U3) in their respective order.

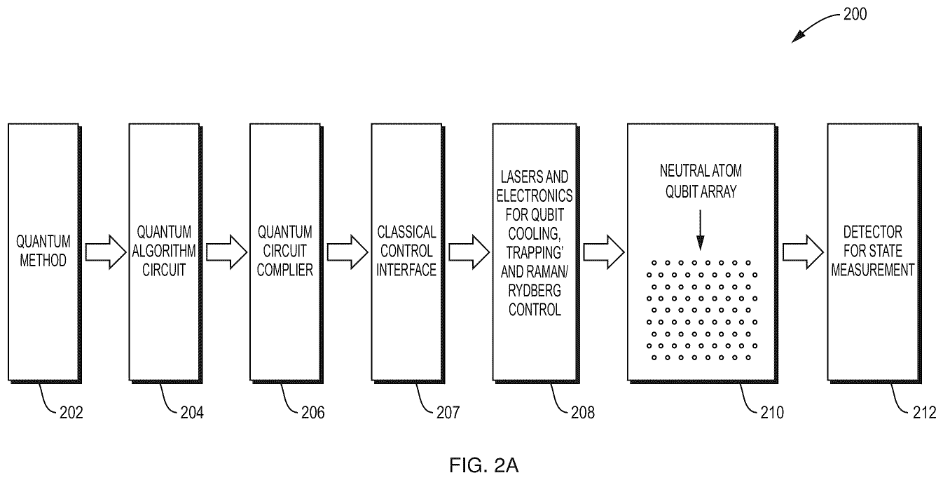

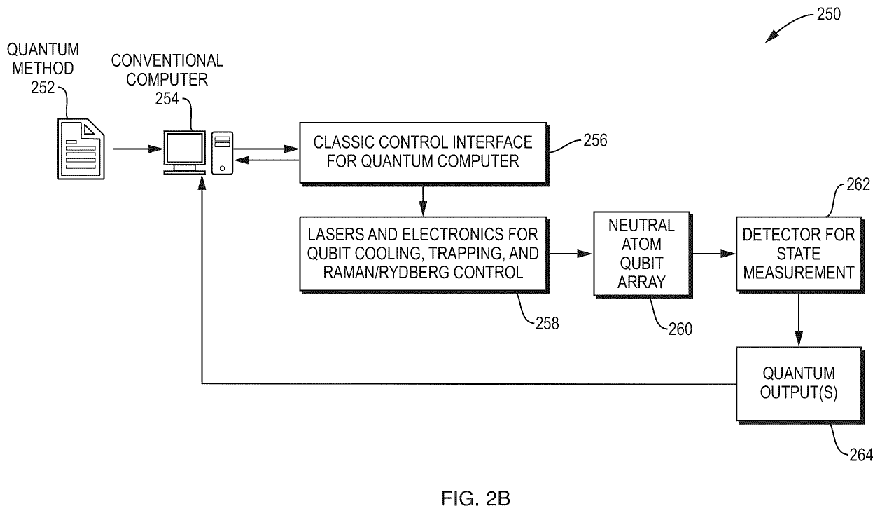

FIG. 2 is a flow diagram 200 illustrating an example embodiment of the method of the present disclosure. Neutral atom quantum stack includes circuit compilation and classical control interface, as well as electronics for qubit control and measurement. Multiple quantum computing technologies (e.g., superconducting qubit, neutral atom, trapped ion, and photon) are rapidly maturing. It is likely that different manufactures will continue to pursue a wide variety of these technologies and exploit the specific technological advantage of individual technologies for different types of quantum programs. In particular, neutral atom offers the specific advantage of being able to natively execute multi-qubit gate operations.

FIG. 2 illustrates the flow of program execution on a neutral atom quantum architecture. First, the logical circuit of the quantum method (202) is compiled using a quantum compiler to reduce its size and make it hardware-compatible (204). The compiled circuit is then fed to a classical interface (207) to execute the gates on a quantum computer (206). On the neutral atom quantum architecture, lasers are used to control the atoms (208). It is known in the art that the control of one atom is equivalent to the control of one qubit. The energy levels of the valence electron of Cesium or Rubidium atoms are used to realize qubit states.

Unlike superconducting-qubit quantum computers, neutral atom qubits are configured in an array (210) but are not connected via physical links. The neutral atom qubits are entangled using Rydberg interactions. Optical tweezers with laser cooling and trapping are used to arrange the atoms in a desired fashion. Then, lasers of different wavelengths are used to prepare, control, and measure qubit states. Lastly, photo-detectors are used to measure the qubits (212).

FIG. 2B is a block diagram 250 illustrating an example embodiment of the present disclosure A conventional computer 254, connected with a classical control interface for a quantum computer 256, analyzes a quantum method 252. In other embodiments, the role of the conventional computer 254 can be implemented by software, hardware, firmware, or a combination of the above. The quantum method 252 is a set of instructions to be executed on a quantum computer. The quantum method 252 is further a set of instructions for a 1-qubit or 2-qubit based quantum computer. The conventional computer 254 processes the quantum method 252 to determine a set of instructions for a three-or-higher-qubit quantum computer based on the methods disclosed herein. The conventional computer 254 processes the quantum method 252 based on the arrangement and status of the neutral atom qubit array 260 as reported to the conventional computer 254 by the control interface 256. For example, the control interface 256 can report active qubits, current entangled qubits and restriction zones, as well as inactive and non-restricted qubits. The quantum computer, using the control interface 256, lasers and electronics for qubit cooling, trapping, and Raman/Rydberg control 258, neutral atom qubit array 260 can then perform an operation based on the modified method determined by the computer 254. Detectors for state measurement 262 then measure the qubits and report a quantum output 264. Optionally, the quantum output 264 is reported to the conventional computer 254.

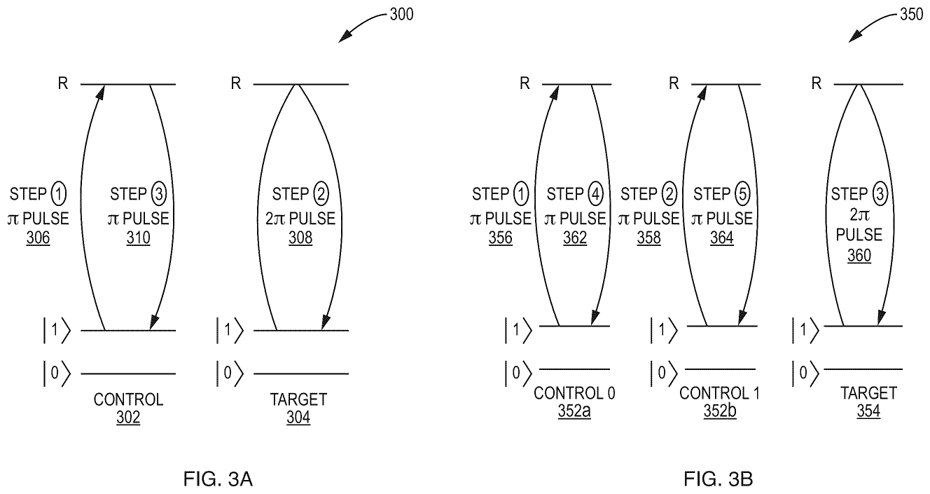

FIG. 3A is a diagram 300 illustrating pulse steps corresponding to a CZ gate. The pulses 306, 308, 310 are executed/emitted in the order enumerated, with the control qubit 302 being excited with the π pulse and the target qubit 304 being excited with the 2π pulse. The lines indicate the energy levels of the valence electron, where 0 is the ground state, 1 is the hyperfine state, and R is the Rydberg state.

FIG. 3B is a diagram 350 illustrating pulse steps corresponding to a CCZ gate. The pulses 356, 358, 360, 362, 364 are executed/emitted in the order enumerated, with the control qubits 352a-b being excited with the π pulse and the target qubit 354 being excited with the 2π pulse. The lines indicate the energy levels of the valence electron, where 0 is the ground state, 1 is the hyperfine state, and R is the Rydberg state.

Multi-qubit gates can be implemented on neutral atom architectures. One-qubit (U3) gates are applied using Raman transitions among qubit states and require only one physical light pulse. On the other hand, the two-qubit CZ gate, as shown in FIG. 3A, requires Rydberg transitions with three light pulses in total.

Unlike Raman transitions, which are internal to an atom, Ryberg transitions depend on interactions among neighboring atoms. First, a π pulse (a light pulse with an area of π) is applied to the control qubit to knock it to the Rydberg state (an energy state with a high quantum number) if it is in the 1 state. This will block qubits in its vicinity to achieve the Rydberg state—a property that is used to entangle nearby qubits. Next, the nearby target qubit is supplied with a 2π pulse. Last, a π pulse is again applied to the control qubit. These three pulses help achieve the CZ gate. Similarly, as illustrated by FIG. 3B, the CCZ gate is achieved using the illustrated five pulses 356, 358, 360, 362, and 364. Note that the applied pulses are independent of the qubit state; on the other hand, the effect of the pulses is dependent on qubit states. For example, if the control qubit is in the 0 state, the pulses will be off-resonant and the qubit will not jump to the Rydberg state.

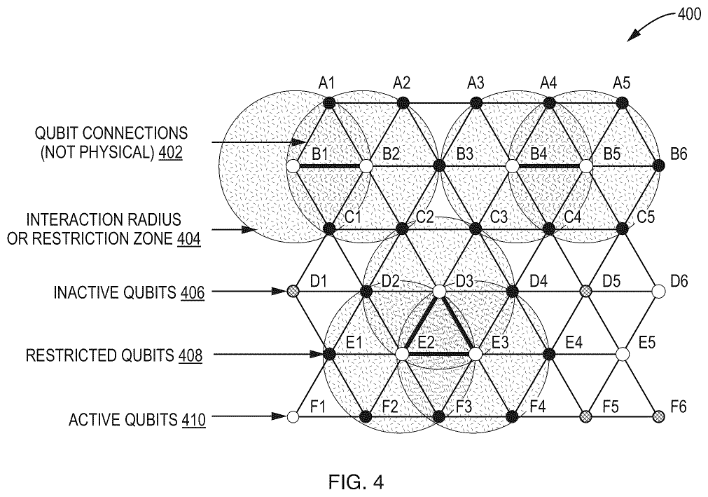

FIG. 4 is a diagram 400 illustrating an example embodiment of a snapshot of operation executions at a given moment in time. FIG. 4 illustrates six operations are taking place: three one-qubit (on qubits D6, E5, and F1), two two-qubits (B1-B2 and B4-B5), and one three-qubits (D3-E2-E3). The active qubits 410 (e.g., qubits with operations taking place) are illustrated in white, the restricted qubits 408 are illustrated black, and the inactive qubits 406 are illustrated in grey. Qubits executing multi-qubit operations are shown with the corresponding restriction zones 404 and are connected via thick lines (e.g., the D3-E2-E3 operation restricts qubits C2, C3, D2, D4, E1, E3, F2, F3, & F4). The qubits are shown to have non-physical connections 402 in a triangular pattern, but other patterns can be implemented.

An important characteristic of neutral-atom quantum computing is the interaction radius or the restriction zone. As described above, multi-qubit gates are achieved by leveraging the Rydberg interaction of atoms. However, while a multi-qubit gate is being performed, qubits that are within the Rydberg interaction radius (e.g., radius of an atom's Rydberg influence) and are not involved in the gate cannot run any other gates.

Essentially, qubits that not engaged in the multi-qubit operation but are within the interaction radius 404 (also referred to as the restriction zone) of any of the qubits which are engaged in the multi-qubit operation, are said to be restricted qubits 408 because these non-involved qubits might inadvertently get entangled with the qubits on which the gate is being run. Thus, the interaction radius 404 of one qubit becomes a restriction zone of other nearby non-involved qubits. FIG. 4 illustrates qubits arranged in a triangular topology, but other topologies can be employed. When multi-qubit gates are executing on a set of “active” qubits 410, other qubits within the restriction zone 404 cannot run any other operations and therefore, become “restricted” qubits 408. As the figure shows, a two-qubit operation (B1-B2 and B4-B5) can at most restrict operations on eight nearby qubits, while a three-qubit operation (E2-E3-D3) can at most restrict operations on nine nearby qubits. On the other hand, a one-qubit gate (D6) (E5) (F1) can be run on qubits without generating any restriction zones 404 as the gate does not rely on the Rydberg interaction among the qubits.

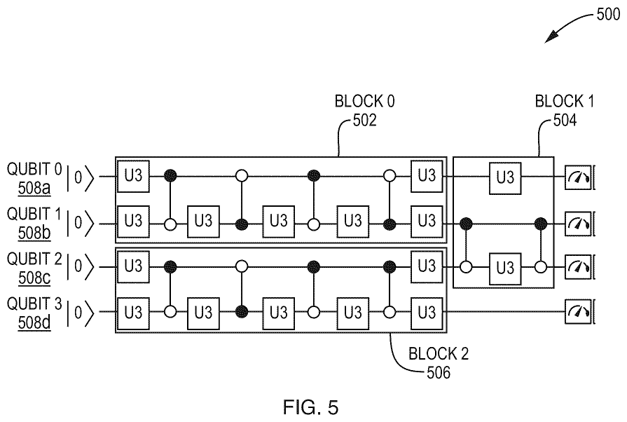

FIG. 5 is a block diagram 500 illustrating an example embodiment of blocking a quantum circuit into three blocks 502, 504, 506. The circuit in total uses four qubits 508a-d, but Block 0 502 uses qubits 0 and 1 508a-b, Block 1 504 uses qubits 0, 1, and 2 508a-c, and Block 2 506 uses qubits 2 and 3 508c-d.

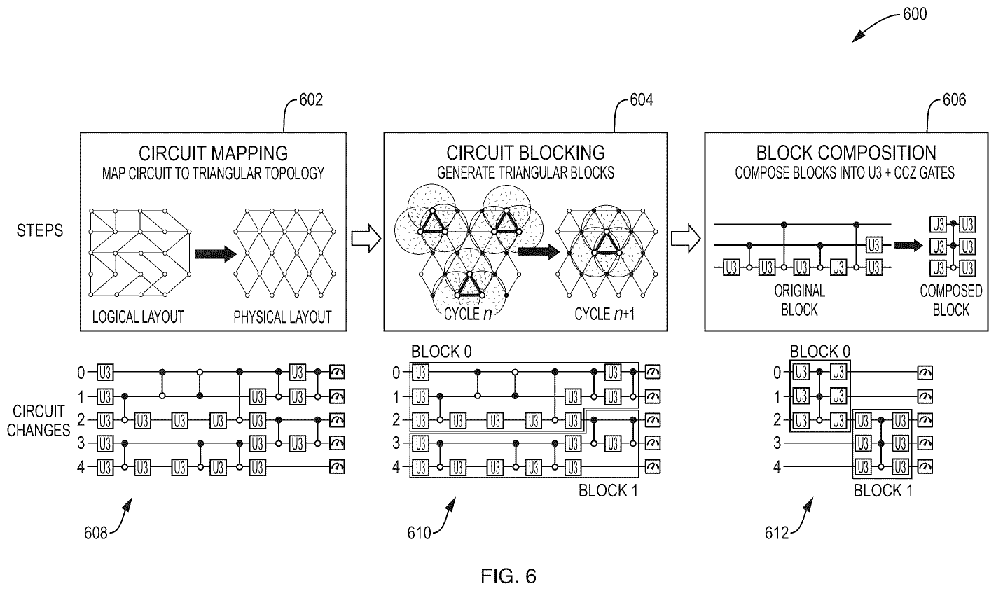

FIG. 6 is a flow diagram 600 illustrating steps of the present method and corresponding system circuit mapping 602, 608, circuit blocking 604, 610, and block composition 606, 612. Circuit mapping 602, 608 includes mapping a logical quantum method circuit to a physical triangular topology. Circuit mapping is the task of taking a logical quantum circuit and converting it into a neutral atom hardware-compatible physical circuit with hardware-supported gates and qubit interactions. This is done by converting logical gates into their physical equivalents (e.g., converting CX to CZ and H as shown earlier) and inserting SWAP operations as necessary. SWAP operations help transport qubit states to enable two qubits that are connected logically, but not physically, to interact with each other. While the mapped physical circuit map have a different set of gates than the logical circuit, the two are mathematically equivalent (e.g., have the same unitary representation U).

Circuit blocking 604, 610 includes creating the minimum number of concurrently-executable three-qubit blocks out of the mapped circuit. A circuit block (or block circuit, quantum block circuit, block quantum circuit) in a quantum circuit refers to a set of self-contained quantum operations and corresponding qubits engaged in those operations. Therefore, circuit blocking is the step of determining circuit blocks from a quantum circuit. Quantum operations within a block do not interact with qubits outside the block within the span of the block. A quantum circuit can be represented as a combination of multiple circuit blocks and a quantum circuit can have multiple equivalent representations in terms of circuit blocks. That is, the same quantum circuit can be represented by multiple different combinations of circuit blocks.

Each circuit block has multiple useful properties. Each quantum gate in the original quantum circuit is a part of only one circuit block. A quantum circuit can have multiple blocks over time and a qubit can be a part of multiple circuit blocks over time, but it can be a member of only one circuit block at any given time. That is, as the quantum operations change, the method can re-evaluate how the circuits are blocked and create new/changed circuit blocks for each instruction. Each circuit block can be represented by its own unitary (e.g., unitary matrix). Consequently, a quantum circuit can be essentially represented as a sequence of circuit blocks—the original quantum circuit's unitary is the product of unitary matrices of individual blocks.

Block composition 606, 612 generates equivalent block circuits with direct three-qubit gates that require fewer pulses. Block composition or circuit composition refers to finding a mathematically equivalent set of gates that represent a given set of gates. In general, the purpose of finding a different set of gates which is mathematically equivalent is to reduce the number of gates or pulses to accomplish the same computation. Running fewer pulses reduces the noise side-effects on near-term erroneous quantum computers and results in higher output fidelity.

Block or circuit composition 606, 612 is essentially the reverse of circuit decomposition. For example, in decomposition, three-qubit gate can be “decomposed” into multiple single- and two-qubit gates that the underly hardware supports. Neutral-atom architectures natively support three-qubit gate operations and hence, the circuit composition can reduce a set a of one- and two-qubit operations to an equivalent three-qubit operation when feasible and does not affect the meaning of the program. This procedure is described in further detail below.

Hilbert-Schmidt Distance (HSD). A distance metric is needed to implement the above method to represent the mathematical equivalency of two circuit unitaries for circuit composition. In one embodiment, the Hilbert-Schmidt distance metric is employed due to its lower computational overhead compared to other metrics. A person of ordinary skill in the art can understand that other distance metrics can be used.

The Hilbert-Schmidt inner product is defined as Tr(U₁^{†}U₂) between unitaries U₁ and U₂ representing the two circuits. The value of this metric is in the range [0,2ⁿ], and the closer the value is to 2ⁿ, the higher the equivalency of the two unitary matrices. This inner product is transformed into a distance metric:

$${〈 {U}_{1} , {U}_{2} 〉}_{HS} = 1 - \frac{\vert \vert Tr ( {U}^{†} {U}^{′} ) \vert \vert}{{2}^{n}} ,$$

which is referred to as the Hilbert-Schmidt distance or HSD. This distance is in the range [0,1] and the closer the value is to 0, the smaller the distance.

A distance metric for output distributions is also needed to quantify the equivalency of two output distributions (e.g., calculate the deviation of the output of a circuit run on a noisy quantum computer from the ideal output). A probability distribution distance metric that is primarily used for this is the total variation distance or TVD. The TVD can be calculated as ½ Σₖ₌₁^{k=2}^{ⁿ}|p₁(k)−p₂(k)|, where p₁(k) is the probability of state k with the first circuit and p₂(k) is the probability of state k with the second circuit.

As illustrated by FIG. 6, the present method and corresponding system employs a three-step procedure toward reducing the circuit size (number of pulses) of a given quantum circuit on a neutral-atom architecture. The first step in this procedure is circuit mapping 602, 608. Circuit mapping involves the procedure of converting the logical quantum circuit/layout into physical gates (U3, CZ, and CCZ) which are natively supported on the neutral-atom quantum architecture. As described below, this step also involves mapping the logical circuit to the hardware topology of neutral atoms (e.g., arrangement of neutral atoms).

The next step is circuit blocking 604, 610. Recall that circuit blocking includes finding a set of self-contained quantum operations and corresponding qubits engaged in those operations. For the present system and method, the objective of this step is two-fold: (1) find blocks that are independent of each other and hence, can be executed concurrently to maximize parallelism; and (2) find large-enough blocks. It is possible to break the circuit into a set of circuit blocks in multiple possible ways, which lends to multiple configurations. In some configurations, all circuit blocks could be dependent on each other and hence, need to be executed sequentially. The present system and method attempts to maximizes the parallelism opportunity by preferring the configuration where multiple blocks can be executed in parallel, or are independent from each other as shown by circuit 610. However, a competing trade-off is also the size of the circuit blocks. Larger circuit blocks allow the present system and method more opportunity for composing the gates (e.g., converting a set of single- and two-qubit gates to three-qubit gates) and hence, reducing the side effects of noise/errors. Unfortunately, large blocks limit the number of blocks that can be executed in parallel. While this trade-off space is an NP-hard problem to solve optimally, a scalable method to solve it effectively is disclosed herein.

The last step of the present method and corresponding system is the composition of circuit blocks 606, 612. This step includes generating equivalent circuits for the blocks formed in the previous step such that the composed circuits leverage the opportunity of running three-qubit gates directly on the qubits to reduce the number of pulses required and resultingly, reducing the noise effects of errors in pulse application. The design and optimization of circuit blocking is described in further detail below.

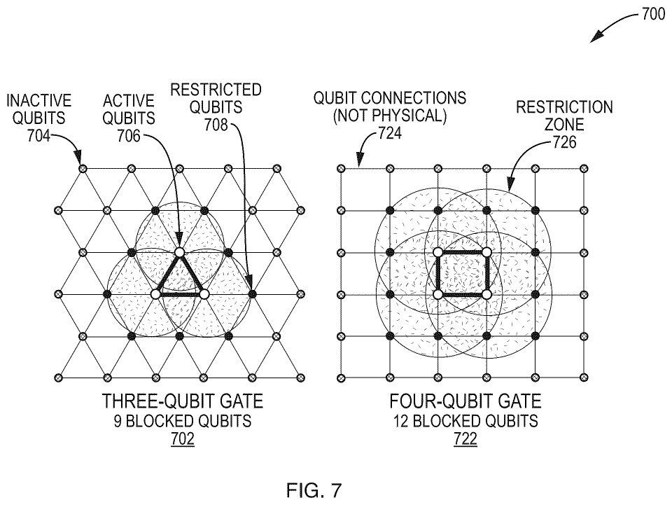

FIG. 7 is a diagram illustrating three-qubit 702 and four-qubit gates 722. FIG. 7 illustrates their corresponding inactive qubits 704 shown in gray, active qubits 706 shown in white, restricted qubits 708 shown in black. Qubit connections 724 are not physical, but shown by a thin line when the qubits are not active together, and in a thick line when they are in a qubit together. The present system and method can be employed to convert a circuit having one- or two-qubits to greater than three-qubits, such as three-qubit gates or four-qubit gates. However, the embodiment of converting to the block size of three-qubits (e.g., using atoms best arranged in a triangular topology) is described herein as opposed to a larger block size of four qubits (e.g., atoms best arranged in a square topology) because it results in blocks that are easier to compose and fewer blocked qubits due to the smaller restriction zones.

An attractive aspect of neutral atom quantum computing, compared to its competing technologies is that its qubits (atoms) can be arranged in any desired fashion. Prior engineering works have demonstrated the arrangement of atom in any of a variety of shapes (e.g., in the shape of Eiffel tower). For practical feasibility and efficiency in the present method and corresponding system, the atoms being arranged in a grid with some pattern-based distance properties ensures Rydberg interactions. For example, layoug 702 shows the qubits being arranged in a triangular grid, while layout 722 shows the qubits being arranged in a square grid.

While the square grid arrangement appears to be the default choice in some cases, especially in superconducting-qubit architectures, this default choice has notable disadvantages in the context of neutral-atom based quantum architecture. The qubits in a square grid are not equidistant to their neighbors: the distance of an qubit to its perpendicular neighbor is less than its distance to its diagonal neighbor. This means that the qubits need to have greater interaction distance to be able to interact with the diagonal neighbor. While this enables the execution of four-qubit gates (e.g., control control control z, or CCCZ), it also results in the larger restriction zone of 12 blocked qubits as shown in four-qubit gate 722 compared to nine blocked qubits in three-qubit gate 702. While the triangular grid 702 restricts nine other qubits during execution, a square grid 722 restricts 12 qubits to run the four-qubit gate. Therefore, embodiments of the present method and system opt for a triangular arrangement of neutral atoms, although it can be extended to other topologies.

Another important consideration behind the choice of triangular topology is the ability to compose three-qubit gates 702 vs. the ability to compose four-qubit gates 722. It is significantly more challenging to compose a four-qubit operation from a given set of single-qubit and two-qubit operations, compared to composing a three-qubit operation. Intuitively, it is harder for quantum programmers to reason about program correctness with multi-qubit gates. Quantum algorithms are rarely written with four-qubit gates because it requires mathematical reasoning in terms of 24×24=256 components. Four-qubit gates are also difficult to compose computationally from a sequence of one-qubit and two-qubit operations. In comparison, three-qubit blocks are 4× easier to compose because they can be represented using only 64 components as opposed to 256 components. Thus, embodiments of the present method and system using three-qubit blocks aligns well with its design decision to use a triangular topology.

In terms of mapping the logical circuit to a physical topology, existing mapping solutions for superconducting-qubit quantum computers can be leveraged. Recall that the input circuits of quantum algorithms only consist of one- and two-qubit gate operations, and embodiments of the present method's and corresponding system's circuit composition step introduces three-qubit gate operations after the circuit blocking step. Therefore, existing superconducting-qubit mapping solutions can be applied in the circuit mapping phase, however, the present disclosure provides embodiments for optimization of this process below. The details of circuit mapping are as follows.

The topology specified to the compiler simply needs to be defined as a set of qubit connections are illustrated in three-qubit gate 702 of FIG. 7. Even though these connections are not physical on neutral atom architecture, they accurately depict all possible qubit interactions in a triangular topology. In addition, the basis gates of {U3, CZ} are provided to the compiler. In an embodiment, the Qiskit compiler performs this mapping because it is a state-of-the-art compiler that runs a variety of optimization passes (e.g., leveraging quantum properties to delete gates and apply heuristics for gate routing) to perform mapping with as few physical gates as possible. However, these optimizations are not sufficient for neutral-atom quantum computing, as is shown further below in the results section because the compiler does not support circuit composition to execute multi-qubit gates. Nonetheless, it offers a reasonable framework for performing circuit mapping. Once the circuit is mapped, circuit blocking can be implemented.

Method 1 - Method for circuit blocking.

```
*Initializing the method and variables*
Q ← Qubits involved in the circuit
O ← Original circuit operations of qubits
F ← Frontier operations of qubits
B ← Blocked circuit (ø)
while F(q) < length(O(q)) for any q ∈ Q do
  T ← All possible three-qubit blocks from the qubit frontiers to as far
    into the circuit as possible
  N ← Number of operations of all blocks in T
  f ← Block family with most operations (ø)
  for t ∈ T do
    fₜ ← Recursively determine ablock family with the most
      operations starting at block t, while respecting the
      restriction zones of the blocks
    if Num. ops. in fₜ > Num. ops. f then
      f ← fₜ
    end if
  end for
  Add f to B
  Update F to last operations of blocks in f
end while
return B
```

The key goal of circuit blocking is to block the circuit in a manner that the minimum number of blocks are generated, while ensuring that as many of these blocks are executed in parallel as possible to reduce the circuit execution time. In an embodiment, the method employed for this blocking procedure is provided by Method 1, above.

In some embodiments, the present system and method Geyser performs blocking in a pulse-aware manner. While current work, mainly in the domain of superconducting-qubit quantum computing technology, has focused on optimizing the number of gates in the circuit, embodiments of the present method and corresponding system focus on minimizing the number of pulses required to execute these gates. This is because not all quantum gates are built similarly. Depending on the gate being run, the controller may need to execute different number of pulses. As the execution time of the circuit as well as the noise experienced by it is ultimately dependent on the number of pulses that are run to execute the circuit, having a gate-level focus may result in sub-optimal results. For example, recall that FIG. 3A illustrates that three serial pulses are required to execute the CZ gate and FIG. 3B illustrates that the five serial pulses are required to execute the CCZ gate. Thus, it takes 67% longer to execute the CCZ gate as compared to the CZ gate, and it may also experience that much more error. To account for this, circuit blocking directly minimizes the number pulses that are required to execute the circuit.

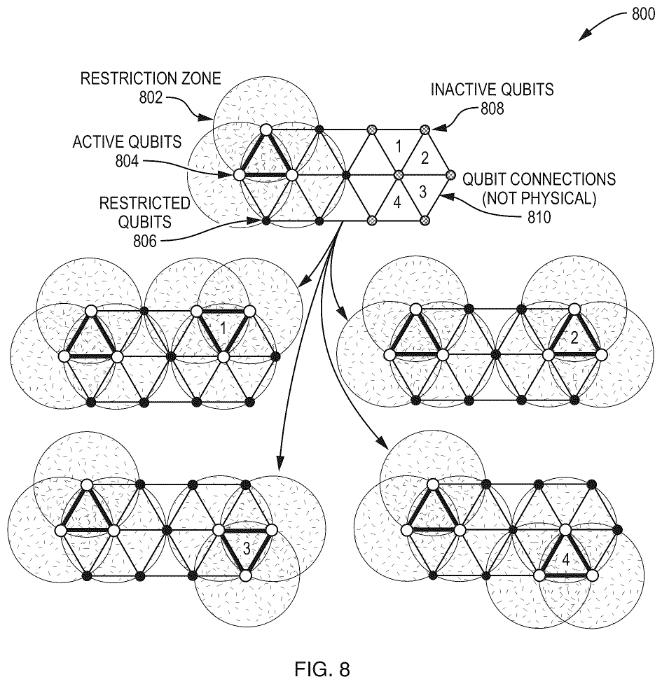

FIG. 8 is a diagram 800 illustrating the formation of blocks. The active qubits 804 (e.g., qubits with operations taking place) are illustrated in white, the restricted qubits 806 are illustrated black, and the inactive qubits 808 are illustrated in grey. Qubits executing multi-qubit operations are shown with the corresponding restriction zones 802 and are connected via thick lines. The formation of blocks maintains a “frontier” of gates, and then recursively constructs concurrently executable block families. During a given round, the blocks are selected one-by-one to form a block family. In this example, there are four mutually-exclusive block possibilities to add to the block family after the first block is selected. These block possibilities are illustrated as 1, 2, 3, and 4. As no further blocks can be selected in this example, the two-block family with the highest number of operations is finalized for the round. This procedure is continued until the end of the circuit is reached and the entire circuit has been blocked.

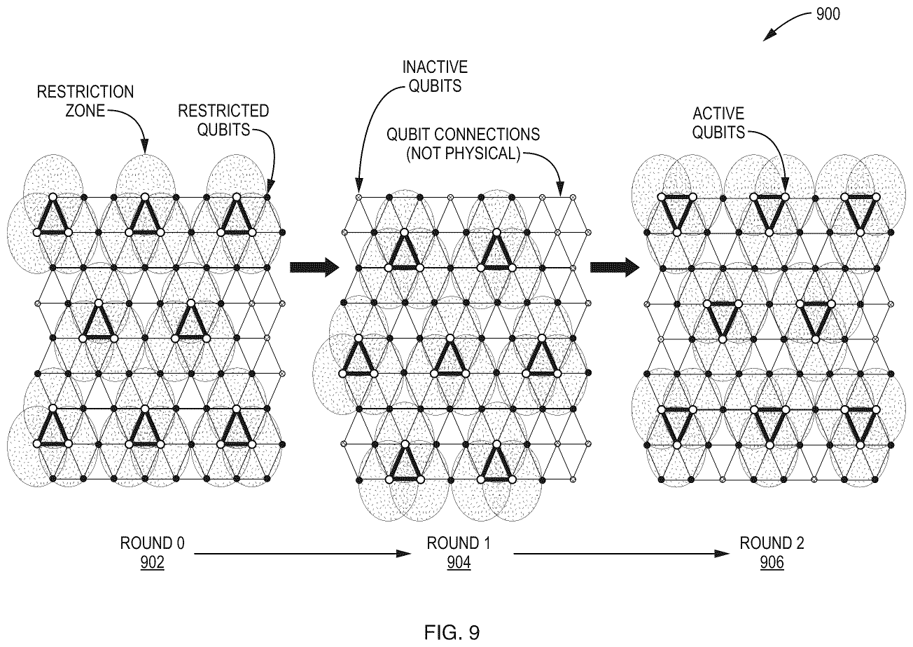

FIG. 9 is a diagram 900 illustrating round-by-round 902, 904, 906 block formation procedure such that block families having the maximum number of operations are formed at any given round. The rounds include forming the blocks according to their restriction zones to enable them to execute in parallel during the same round. Once the blocks are formed, block composition can be performed for each block.

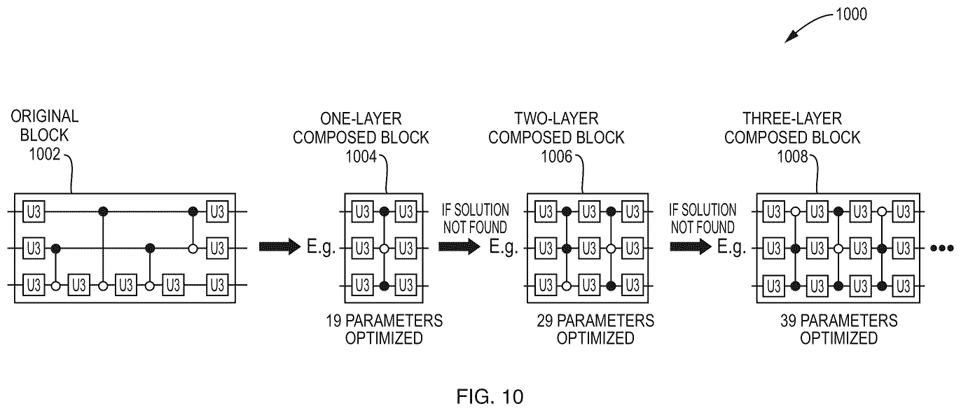

FIG. 10 is a diagram 1000 illustrating an example embodiment of block composition, starting from an original block 1002 to a composed block 1004, 1006, or 1008. A block is composed layer-by-layer. Starting with just forming a one-layer composed block 1004, the 19 parameters (6×3=18 angles between 0 and 2π from the U3 gates and 1 categorical parameter to choose among the three CCZ configurations) are optimized to find a block with a close Hilbert-Schmidt distance to the original block. If a solution is not found with the one-layer composed block 1004, another layer is added to create a two-layer composed block 1006 and a 29-parameter optimization is performed. Again, if a solution is not found with the two-layer composed block 1006, then another layer is added to create three-layer composed block 1008 and a 39 parameter optimization is formed. The procedure is continued until a solution is found or the number of pulses in the composed block surpasses the number of pulses in the original block.

Method 2 - Method for block composition.

```
O ← Original block circuit
C ← Composed block circuit (ø)
L ← Parameterized layer of U3 and CZ or CCZ
ϵ ← Distance threshold
while ( [symbol]   C, O [symbol]   _{HS} > ϵ) & (length(C) < length(O))
  Append L to C
  Optimize parameters in C to minimize [symbol]   C, O [symbol]   _{HS} using a dual
    annealing-based optimizer
end while
if length(C) ≥ length(O) then
  return O
else C
```

Block composition refers to reducing the number of pulses required for a block by finding an equivalent block circuit with three-qubit gates. The composition procedure is conducted layer-by-layer as the composed circuit is built and as illustrated by FIG. 10. Method 2 details the procedure of composing a block. All formed blocks across all rounds can be independently composed in parallel. Starting with one layer of three U3 gates (one U3 gate on each qubit), one CCZ gate and three more U3 gates, the parameters of the gates are optimized to minimize the HSD between the unitaries of the two block circuits.

As discussed above, a CCZ gate requires two more pulses than the CZ gate. However, the CCZ has an important use case because it is able to capture in five pulses what would otherwise take 26 pulses to run with CZ gates.

In composing the gate, the method begins with just one layer as it has the fewest number of pulses (eleven pulses: one from each U3 and five from the CCZ). Both, U3 and CCZ are parameterized gates as illustrated in FIG. 10. U3 has the three rotational angles, while CCZ has the option to decide the target qubit among the three qubits, resulting in 19 parameters in total. Note that the two form a universal gate set. For each configuration in the parameter space, there exits a corresponding circuit with the corresponding unitary matrix, whose distance can be calculated to the original unitary. These parameters are optimized to calculate and minimize this distance using a dual annealing process. If the distance goes below the desired threshold, the parameter configuration is chosen to represent the composed circuit.

On the other hand, if a distance below the desired threshold is not obtained at the end of the dual annealing search procedure, another layer is added, allowing an optimization space of 29 parameters in total. This can help achieve a smaller distance, while also increasing the pulse count. If still the distance threshold is not met, then a third layer is added. This process continues until either the distance threshold is achieved or the pulse count of the composed circuit exceeds the pulse count of the original circuit. In this case, it is better to use the original block circuit for the final execution. Once all blocks are composed, the full composed circuit is formed by putting the composed blocks together. This composed circuit requires fewer pulses than the original mapped circuit and reduces the execution time as well as the noise effects as discussed below. Embodiments of the present method and corresponding system have a low overhead and scales efficiently as discussed below.

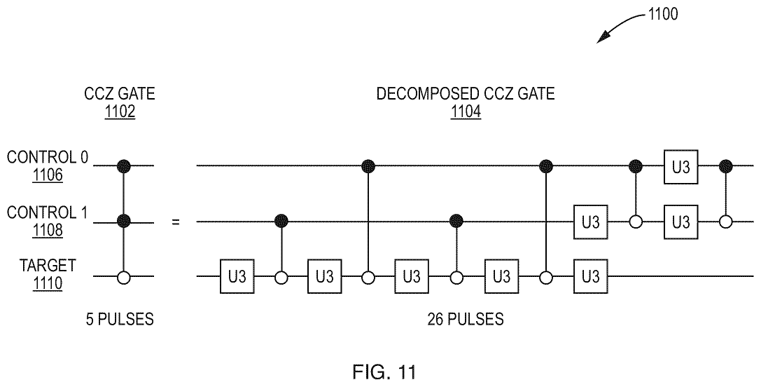

FIG. 11 is a diagram 1100 illustrating the decomposition of a CCZ gate 1102 into a decomposed CCZ gate 1104 of one-qubit U3 and two-qubit CZ gates. Recall that it would not be possible to run this CCZ gate directly on a superconducting-qubit quantum computer, and thus, it would take 26 pulses (3×6=8 from the six CZ gates and 1×8=18 from the eight U3 gates) to run this gate on superconducting qubits (e.g., the decomposed CCZ gate 1104). On the other hand, neutral atom architecture makes it possible to run this gate directly in five pulses with the CCZ gate 1102. Therefore, this gate is used in the layers of block composition.

The unitary corresponding to the original block circuit is referred to as the original unitary, while the one corresponding to the composed circuit is referred to as the composed unitary. If the distance between these two unitaries is minimized below a certain threshold (e.g., 1e−5), then the two circuits can be considered equivalent. HSD is used for this process as opposed to the TVD because individual blocks do not have any output of their own. However, the impact of evaluating the entire circuit using TVD is described below.

Embodiments of the present method and corresponding system were evaluated primarily driven via simulation using representative characteristics and technological parameters of neutral-based quantum architectures including interaction radius and atom distance.

An embodiment of the present system and method, Geyser is run on a local data center consisting of Intel® Xeon® CPU E5-2690 v3 @ 2.60 GHz nodes, but a person of ordinary skill in the art can employ other data centers or computers. Each node of the data center has two sockets, each with 12 physical cores (48 logical cores total), and a memory capacity of 128 GiB. The Python 3.8.8 framework was used execute all the steps involved in Geyser. Because the circuit blocks can be scored and composed in parallel without any dependencies, we use multiprocessing to score and compose the blocks concurrently.

Qiskit 0.18.3 performs the mapping step as described above. The qiskit-aer 0.9.1 library performs unitary simulation to calculate HSD during composition. The qiskit-ibmq-provider 0.18.0 library simulates noisy circuits in the IBMQ QASM simulator in the IBMQ cloud. The evaluation uses representative one-qubit and multi-qubit gate errors on par with the state-of-the-art neutral atom implementation. The noise model includes both bit-flip and phase-flip errors with 0.1% occurrence rate on one-qubit operations. The one-qubit error matrix is then self-tensored to generate two-qubit and three-qubit error matrices. To further demonstrate the robustness of Geyser, the evaluation results correspond to error rates 0.05% and 0.5%. Lastly, the scipy 1.6.2 library is used to optimize (e.g., minimize) the HSD during composition using dual annealing.

Comparatively, the “Baseline” technique includes with mapping and scheduling a given circuit on to a triangular topology for execution on neutral atom architecture. It does not include any mapping optimizations. In addition to the steps taken in the Baseline technique, the OptiMap technique includes all state-of-the-art optimizations that are performed by Qiskit, including gate cancellation and gate synthesis. Finally, in addition to the steps in the OptiMap technique, Geyser performs blocking and composition as described above.

The present method can be compared to running the circuit on a superconducting-qubit architecture. This comparison is performed to evaluate the neutral-atom architecture's relative potential compared to the superconducting-qubit architecture. While this comparison is useful, it is sensitive to technological advances for both architecture types. To provide a more favorable comparison for superconducting-qubit architecture, the same noise levels are used as for neutral-atom architectures and use all of the Qiskit mapping optimizations, although some recent physics studies provide evidence that neutral-atom based architecture might be able to achieve lower error rate in a more relaxed cooling environment than superconducting qubits.

Furthermore, the circuit is mapped on to a square grid to simulate a best-case scenario for superconducting-qubits—typically, superconducting qubits are laid out in a hexagonal grid to minimize interference, which results in fewer qubits connections than square grid and requires more SWAP gates.

TABLE 1
Benchmarks used to evaluate Geyser.

| | | | | Num. | Num. |
|---|---|---|---|---|---|
| | Num. | Num. | Num. | Total | Depth |
| Benchmark | Qubits | U3 Gates | CZ Gates | Pulses | Pulses |
| Adder? | 4 | 75 | 24 | 147 | 117 |
| VQE? | 4 | 235 | 74 | 457 | 359 |
| QAOA? | 5 | 123 | 48 | 267 | 212 |
| QFT? | 5 | 113 | 39 | 230 | 167 |
| Multiplier? | 5 | 75 | 23 | 144 | 104 |
| Adder | 5 | 380 | 158 | 854 | 605 |
| Advantage? | 9 | 108 | 32 | 204 | 73 |
| QFT | 10 | 1141 | 498 | 2635 | 1629 |
| Multiplier | 10 | 787 | 340 | 1807 | 1136 |
| Heisenberg? | 16 | 15614 | 3339 | 25631 | 8083 |

Table 1 shows the benchmarks used to evaluate Geyser, along with the gate counts and pulse counts in their Baseline circuits. Quantum Alternating Operator Ansatz (QAOA) and Variational Quantum Eigensolver (VQE) are variational quantum algorithms. Adder and Multiplier are quantum arithmetic circuits. QFT is Quantum Fourier Transform and Heisenberg is a Hamiltonian evolution algorithm for material simulations. These algorithms cover a wide range of circuit characteristics

### Evaluation Metrics.

a) Number of Operations (lower is better): This metric calculates the number of gates of different types (U3, CZ, and CCZ) in the final circuit generated by different techniques.
b) Number of Pulses (lower is better): This is the total number of pulses in the circuit. Recall that Geyser directly optimizes the number of pulses as opposed to operations because noise effects are proportional to pulses and different operations can have different pulse counts.
c) Number of Depth Pulses (lower is better): This is the number of pulses in the critical path of the circuit (the path with the highest depth in terms of the number of pulses).
d) Total Variation Distance (TVD) (lower is better): As described above, the TVD of two outputs can be calculated as ½ Σₖ₌₁^{k=2}^{ⁿ} p₁(k)−p₂(k), where p₁(k) is the probability of state k in the first output and p₂(k) is the probability of state k in the second output. We use this metric to evaluate the output fidelity of different solutions by calculating the TVD to the ideal output.

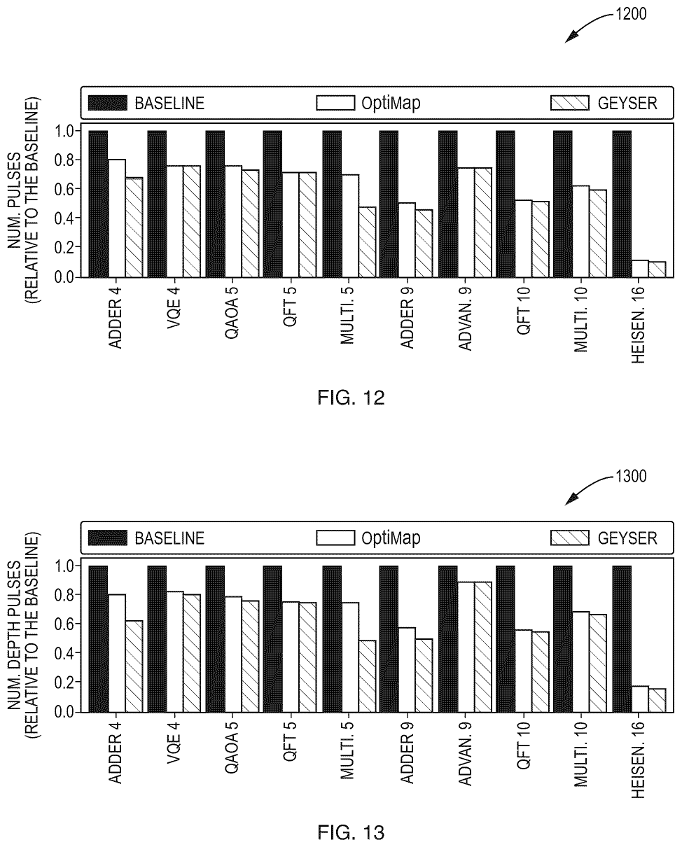

FIG. 12 is a graph 1200 illustrating the present method and corresponding system (Geyser) reducing the total number of pulses in the circuit compared to the Baseline and OptiMap techniques. FIG. 12 shows the number of pulses for different methods being executed when the circuit is compiled using the Baseline, OptiMap, and Geyser techniques.

FIG. 13 is a graph 1300 illustrating the present method and corresponding system (Geyser) reducing the number of pulses in the critical path of the circuit compared to Baseline and OptiMap. FIG. 13 shows the number of depth pulses in the critical path for different methods being executed when the circuit is compiled using the three techniques. Across different algorithms, Geyser achieves a higher reduction in pulse count from the Baseline as compared to OptiMap. As an instance, for the 16-qubit Heisenberg algorithm, the Baseline circuit has a total of 25,632 pulses and 8,083 depth pulses. The OptiMap technique reduces the total pulse count by 90% (2,716 pulses) and the depth pulse count by 82% (1,403). While not shown in the figure, Geyser reduces the total pulse count by a further 9% (2,483) and the depth pulse count by a further 14% compared to OptiMap (1,212). Table 1 denotes pulse and gate count achieved via Geyser and OptiMap. These results indicate the effectiveness of the blocking and composition procedures of Geyser.

The reasons behind this increased effectiveness are discussed below. Geyser reduces the number of U3 and CZ gates compared to Baseline and OptiMap by leveraging CCZ gates to perform complex quantum computations with fewer pulses. Note the raw count is provided for CCZ gates on a log scale as Baseline and OptiMap do not have these gates.

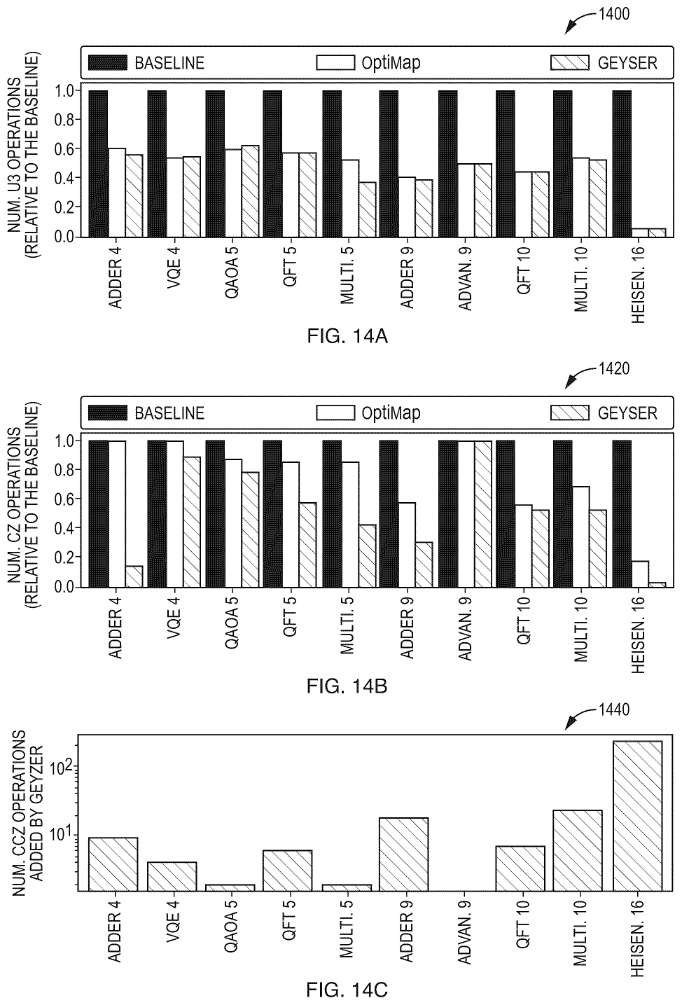

In other words, Geyser achieves reductions in pulse counts by introducing few CCZ gates in place of large numbers of U3 and CZ gates. FIGS. 14A-C are graphs 1400, 1420, and 1440 illustrating the number of U3, CZ, and CCZ gates with the three techniques, respectively. As expected, the Baseline circuits have a high number of U3 and CZ gates and no CCZ gates. In comparison, due to the gate optimizations, the OptiMap circuit have a lower U3 and CZ count, but still no CCZ gates. Note that while Mapping reduce U3 gates considerably, it is not able to reduce the CZ gates as efficiently because two-or-more-qubit gates are difficult to optimize without composition. For example, for the 4-qubit Adder circuit, Mapping reduces U3 gates by 40% (0.6 vs. 1), but it does not reduce CZ gates at all. On the other hand, Geyser is able to further reduce the U3 and CZ gate counts due to the use of the CCZ gates during composition.

The CCZ gates are able to capture the same amount of quantum computational complexity as combinations of the other two gates, but using fewer pulses. Thus, one CCZ gate can replace a relatively long sequence of U3 and CZ gates. However, this opportunity may not be possible for a given algorithm as it relies on the ability to form long blocks. If this is not achievable for a given method (e.g., the 9-qubit Advantage method), then Geyser does not provide improvements over the OptiMap technique. On the other hand, for the 5-qubit Multiplier algorithm with long blocks, as compared to the Baseline technique, Geyser is able to reduce U3 gate count by 63% and CZ gate count by 57%, while introducing two CCZ gates: the U3 pulse count is reduced from 75 to 28, the CZ pulse count is reduced from 69 to 30, and the CCZ gates introduce 10 pulses, resulting in a total reduction of 76 pulses. Next, we study how this reduces output fidelity.

FIG. 15 is a graph illustrating the TVD to the ideal output when the circuit is compiled with the Baseline, OptiMap, and Geyser techniques. The TVD is lowest with Geyser, which is associated with higher output fidelity. FIG. 15 compares the TVDs to the ideal output of the Baseline, OptiMap, and Geyser-generated circuits simulated with the same noise characteristics. The results show the tangible benefits of reducing the number of pulses and the number of pulses in the critical path as the TVD with Geyser is lower than the TVD with comparative techniques. For the 9-qubit Advantage method, which was not able to leverage the composition benefits due to small block size, the TVD with Geyser is similar to the TVD with OptiMap. But in other cases, Geyser improves TVD in the range of 25-60%. For example, for the 5-qubit QFT method, OptiMap improves the TVD over Baseline by 21% and Geyser improves the TVD over Baseline by 32%. Further, Geyser improves the TVD by over 60% for the 5-qubit Multiplier method. In general, OptiMap has a lower TVD than Baseline as it has fewer pulses, while Geyser has even lower TVD due to pulse reduction as a result of block composition.

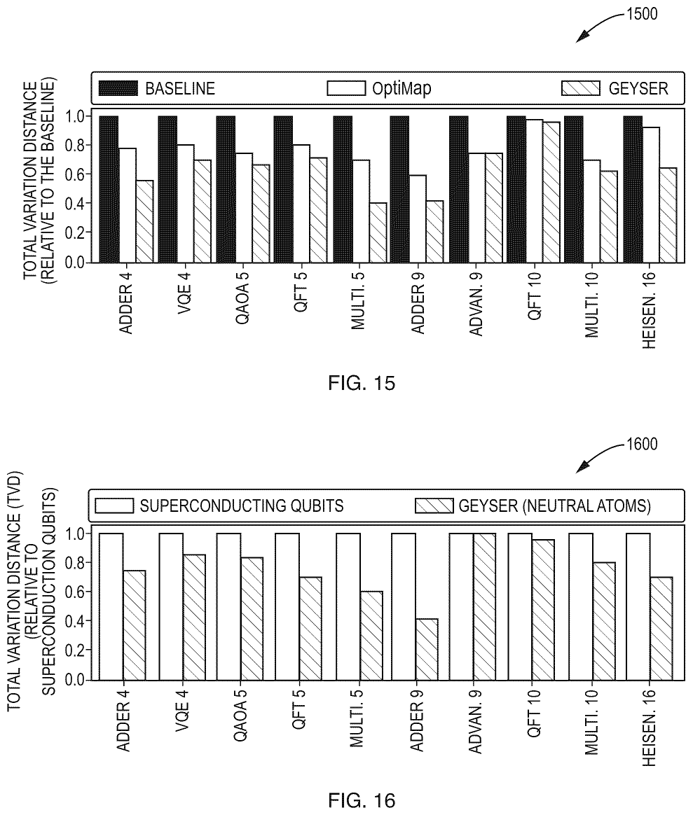

FIG. 16 is a diagram 1600 illustrating the TVD to the ideal output when the circuit is run on superconducting qubits compared to when it is run on neutral atoms with Geyser. The TVD is lower on neutral atoms. Simulating Geyser with a neutral atom circuit yields a lower TVD to the ideal output than the superconducting analog built with corresponding error rates. FIG. 16 shows that a circuit run on superconducting qubits with all of the state-of-the-art Qiskit optimizations has a much higher TVD than the corresponding circuit run with Geyser on neutral atoms. For example, for the 9-qubit Adder circuit, the TVD with Geyser applied for neutral atoms is 57% lower than it is when the circuit is run on superconducting qubits with the same operation errors. This is due to the fact that superconducting-qubit technology is inherently not capable of executing multi-qubit (greater than two qubits) operations. This prevents the circuits run on this technology to be limited in terms of the optimizations that can be performed on them—block composition cannot be performed on superconducting qubits. These results demonstrate the useful benefits of the neutral-atom technology over superconducting qubits.

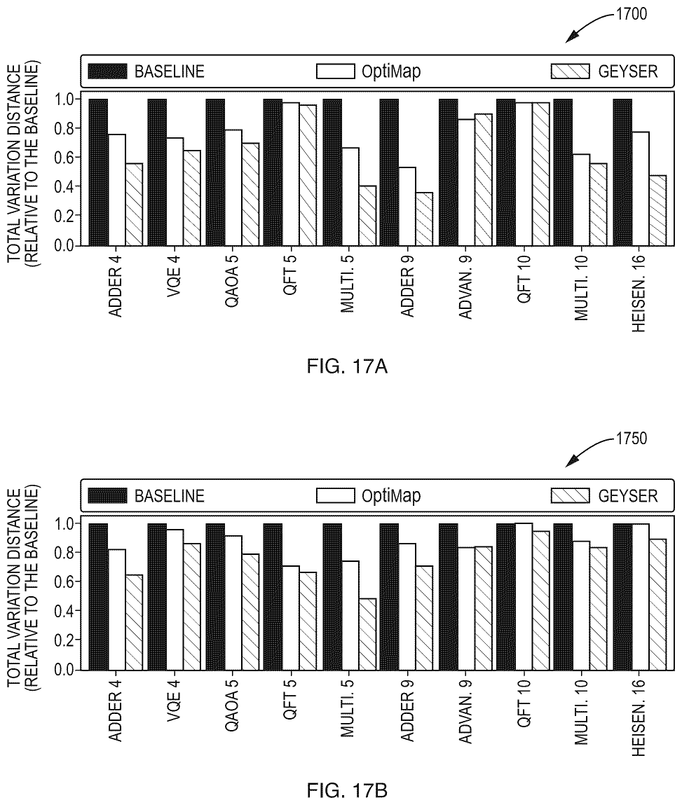

FIGS. 17A-B are graphs 1700, 1750 illustrating a TVD to the ideal output when the circuit is compiled with the Baseline, OptiMap, and Geyser techniques for different error rates. The TVD is lowest with Geyser.

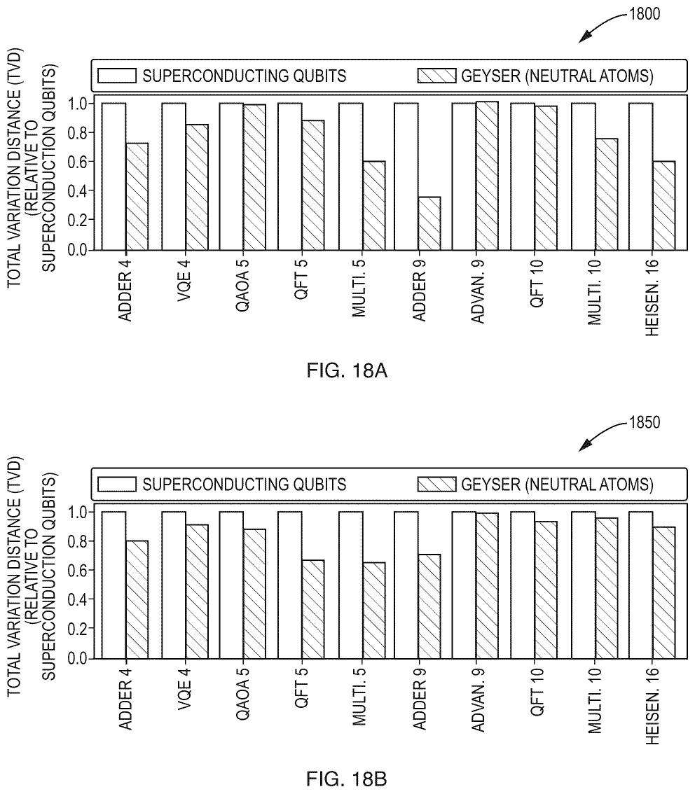

FIGS. 18A-B graphs 1800, 1850 illustrating TVD to the ideal output when the circuit is run on superconducting qubits vs. when it is run on neutral atoms with Geyser for different error rates.

Geyser achieves reduction in TVD compared to competing techniques and superconducting-qubit architectures for different noise levels. FIG. 17 and FIG. 18 illustrate how the behavior of Geyser is affected is the noise level is increased to 0.5% of decreased to 0.05% (compared to the default noise level of 0.1%). The results show that Geyser's benefits remain high for future qubits with lower errors as well. For example, Geyser achieves a 60% reduction in TVD compared to Baseline even if the noise level is decreased to 0.05%. This demonstrates that Geyser's performance characteristics are not restrictively sensitive to the noise levels.

Geyser provides a high circuit fidelity. Recall that Geyser tries to emulate the original circuit's unitary as much as possible during the composition step by minimizing the HSD. However, because the HSD is still non-zero, it is important for the circuit generated by Geyser to give similar output to the output of the original circuit even in the ideal scenario. This is indeed the case because the TVD between the ideal output of Geyser's circuit and the ideal output of the original circuit is practically negligible (<1e−2) across all algorithms.

Neutral atoms can sometimes be knocked out of place when the atom state is being measured. However, the technology to control atom positions and measure them without atom loss has developed considerably in the recent years, resulting in a decreased likelihood of losing an atom. Moreover, lost atoms can easily be replaced by shuttling other unused atoms in their place; atom can be rearranged to realize a loss free register using a take→transfer→release procedure with optical tweezers that load and process a neutral atom computational cycle. Geyser leverages this physically demonstrated capability to mitigate atom loss between shots, and its effectiveness was not experimentally observed to be sensitive for realistic atom loss probabilities.

The time and space complexity of Geyser is important to its scalability. Overall, Geyser scales quadratically with the number of circuit operations (c) as described next. The first step of mapping has a time complexity of O(kc), when k mapping optimization passes are performed. Using the Qiskit compiler for this step, it finishes within a minute across all methods on the experimental testbed. The next step of blocking has a worse-case time complexity of O(c²) as each block is scored, and then, the block family is formed recursively (c blocks are formed in the worst case, although this number is typically much smaller in practice). This step can be performed in parallel for all blocks and also finishes within a minute. The last step of composition has a time complexity of O(c), as each block is composed once and the composition of all blocks can be performed concurrently. It was observed that the time varies based on how many layers need to be added based on the complexity of the block unitary matrix. However, the parameter optimization after each layer addition completes within two minutes on our nodes. The space complexity is proportional to the number of blocks—bounded by O(c).

Current works on quantum circuit compilation and optimization are discussed below. Specifically, in other work a goal is present of recompiling quantum circuits to be more space efficient to speed up execution and reduce noise. However, these works are focused on superconducting quantum circuits, while Geyser is designed for neutral atom circuits to mitigate neutral atom specific challenges and exploit specific advantages that neutral atom technology offers. Note that many of the techniques used to optimize superconducting circuits, which include minimizing additional swap gates are also applicable and useful in optimizing neutral atom circuits (as incorporated in the circuit mapping step of Geyser, which uses Qiskit optimization passes). However, these works do not account for the flexible geometries of neutral atom circuits, the Rydberg interaction blocking, and the native multi-qubit gate support.

In contrast to compilers for superconducting qubits, some current work demonstrates how to compile quantum circuits for neutral atom architectures. The technique relies on the traditional superconducting-qubit methods for mapping and scheduling of quantum circuits given the rules of neutral atom interactions. This technique is comparable to the Baseline technique in our evaluation, as it does not have the optimization passes included in OptiMap. In contrast, Geyser moves the state-of-art of neutral atom compilation and optimization by introducing novel methods for pulse count reduction, composing three-qubit gates, and operation parallelism.

Finally, some current works have made attempts to decompose larger gates into smaller gates. In contrast, Geyser is the first work to solve the inverse problem—that, composing larger gates from smaller gates (e.g., composing three-qubit gates from a set of single- and two-qubit gates, when possible). This is a more challenging optimization problem than decomposing to smaller gates, and a solution to this problem has broader applicability in quantum computing in addition to neutral-atom quantum circuit compilation.

Neutral-atom architectures are one of the more promising quantum computing technologies. However, they have received limited attention from our architecture community and require more exploration to amplify their advantages and build a system software ecosystem around them. Geyser is designed to take advantage of the quantum technology of neutral-atom computation using multi-qubit gates. Using intelligent circuit mapping and novel circuit blocking and composition, Geyser is able to build circuits with fewer pulses, reducing the output error by up to 25%-60%.

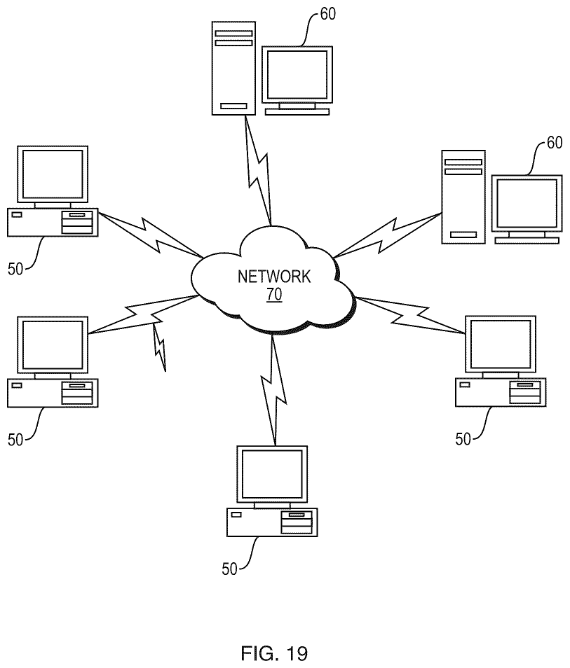

FIG. 19 illustrates a computer network or similar digital processing environment in which embodiments of the present invention may be implemented.

Client computer(s)/devices 50 and server computer(s) 60 provide processing, storage, and input/output devices executing application programs and the like. The client computer(s)/devices 50 can also be linked through communications network 70 to other computing devices, including other client devices/processes 50 and server computer(s) 60. The communications network 70 can be part of a remote access network, a global network (e.g., the Internet), a worldwide collection of computers, local area or wide area networks, and gateways that currently use respective protocols (TCP/IP, Bluetooth®, etc.) to communicate with one another. Other electronic device/computer network architectures are suitable.

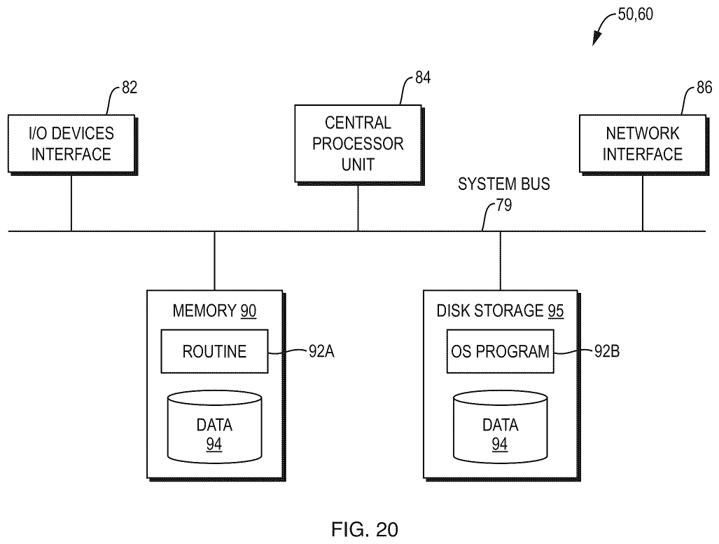

FIG. 20 is a diagram of an example internal structure of a computer (e.g., client processor/device 50 or server computers 60) in the computer system of FIG. 19. Each computer 50, 60 contains a system bus 79, where a bus is a set of hardware lines used for data transfer among the components of a computer or processing system. The system bus 79 is essentially a shared conduit that connects different elements of a computer system (e.g., processor, disk storage, memory, input/output ports, network ports, etc.) that enables the transfer of information between the elements. Attached to the system bus 79 is an I/O device interface 82 for connecting various input and output devices (e.g., keyboard, mouse, displays, printers, speakers, etc.) to the computer 50, 60. A network interface 86 allows the computer to connect to various other devices attached to a network (e.g., network 70 of FIG. 19). Memory 90 provides volatile storage for computer software instructions 92 and data 94 used to implement an embodiment of the present invention (e.g., quantum computer conversion module, blocking module, and circuit composition module code detailed above). Disk storage 95 provides non-volatile storage for computer software instructions 92 and data 94 used to implement an embodiment of the present invention. A central processor unit 84 is also attached to the system bus 79 and provides for the execution of computer instructions.

In one embodiment, the processor routines 92 and data 94 are a computer program product (generally referenced 92), including a non-transitory computer-readable medium (e.g., a removable storage medium such as one or more DVD-ROM's, CD-ROM's, diskettes, tapes, etc.) that provides at least a portion of the software instructions for the invention system. The computer program product 92 can be installed by any suitable software installation procedure, as is well known in the art. In another embodiment, at least a portion of the software instructions may also be downloaded over a cable communication and/or wireless connection. In other embodiments, the invention programs are a computer program propagated signal product embodied on a propagated signal on a propagation medium (e.g., a radio wave, an infrared wave, a laser wave, a sound wave, or an electrical wave propagated over a global network such as the Internet, or other network(s)). Such carrier medium or signals may be employed to provide at least a portion of the software instructions for the present invention routines/program 92.

While example embodiments have been particularly shown and described, it will be understood by those skilled in the art that various changes in form and details may be made therein without departing from the scope of the embodiments encompassed by the appended claims.

The teachings of all patents, published applications and references cited herein are incorporated by reference in their entirety.

What is claimed is:

1. A method of converting a one-bit or two-qubit quantum circuit to a three-or-more-qubit quantum circuit, the method comprising:
for each qubit gate of a plurality of qubit gates of a quantum circuit within a qubit frontier of a circuit operation of one or more qubit gates of the circuit:
determining a set of three-or-more-qubit blocks from the qubit frontier to an interior of the circuit,
determining a number of operations of at least a subset of blocks in the set of three-or-more-qubit blocks,
determining a family of blocks with a highest number of operations,
for each respective three-qubit block of the set of three-or-more-qubit blocks, determining a block family with a highest number of available operations that starts with the respective three-or-more-qubit block and adheres to restriction zones of the blocks, and
adding a three-or-more-qubit block having a highest number of operations to a blocked circuit;
wherein each of the plurality of qubit gates is a one-bit or two-bit qubit gate of fewer bits than a number of bits of the three-or-more-qubit blocks.

2. The method of claim 1, wherein the blocked circuit is a first blocked circuit, the method further comprising:
repeating the operations to create a second blocked circuit, the second blocked circuit representing gates of the quantum circuit that is mutually exclusive from gates representing the first blocked circuit.

3. The method of claim 1, wherein the qubit gates are at least one of a neutral atom qubit gate, a superconducting qubit gate, and a photon-based qubit gate.

4. The method of claim 1, wherein the qubits are arranged in a triangular grid.

5. The method of claim 1, wherein the blocked circuit can change over time or for executing different instructions.

6. The method of claim 1, wherein the restriction zones of the blocks are based on qubits being restricted from engaging in quantum operations depending on nearby qubit activity.

7. The method of claim 1, further comprising:
(a) based on the blocked quantum circuit comprising a plurality of one-qubit gates and two-qubit gates, determining a parameterized layer of three-qubit gates;
(b) adding the determined parameterized layer to a composed block quantum circuit;
(c) determining whether the distance of the blocked quantum circuit and the composed block quantum circuit is below a particular threshold;
(d)(1) if the distance is below the particular threshold, outputting the composed block quantum circuit; and
(d)(2) if the distance is equal to or above the particular threshold, repeating (a)-(d).

8. The method of claim 1, further comprising interfacing with a quantum computer as the computer runs a program, and iterating the operations for different instructions than the quantum computer is executing.

9. The method of claim 1, wherein the set of three-or-more qubit blocks is a set of three-qubit blocks.

10. The method of claim 1, wherein determining a number of operations of at least a subset of blocks in the set of three-or-more-qubit blocks is determining a number of operations of all blocks in the set of three-or-more-qubit blocks.

11. A method of converting a one-bit or two-qubit quantum circuit to a three-or-more-qubit quantum circuit, comprising:
(a) based on an input block quantum circuit comprising a plurality of one-qubit gates and two-qubit gates, determining a parameterized layer of three-or-more-qubit gates;
(b) adding the determined parameterized layer to a composed block quantum circuit;
(c) determining whether the distance of the input block quantum circuit and the composed block quantum circuit is below a particular threshold;
(d)(1) if the distance is below the particular threshold, outputting the composed block quantum circuit; and
(d)(2) if the distance is equal to or above the particular threshold, repeating (a)-(d).

12. The method of claim 11, wherein the particular threshold is based on at least one of the size of the input block quantum circuit and the size of the composed block quantum circuit.

13. The method of claim 11, wherein the distance is at least one of the Hilbert-Schmidt Distance (HSD) and a total variation distance (TVD).

14. The method of claim 11, wherein step (d)(1) further comprises:
if the distance is below the particular threshold and the size of the composed block quantum circuit is greater than the size of the input block quantum circuit, returning the input block quantum circuit.

15. The method of claim 11, wherein the qubit gates are at least one of a neutral atom qubit gate, a superconducting qubit gate, and a photon-based qubit gate.

16. The method of claim 11, wherein determining the parameterized layer further includes determining angles between the three-qubit gates and determining a parameter for the configuration of the three-or-more-qubit gates such that the parameters are optimized to minimize the distance between unitaries of the input block quantum circuit and the composed block quantum circuit.

17. The method of claim 11, wherein the three-or-more-qubit gates are three-qubit gates.

18. The method of claim 11, wherein the parameterized layer includes a plurality of U3 gates and one or more CCZ gate.

19. The method of claim 11, further comprising determining a block circuit to input for input block quantum circuit by:
for each qubit gate of a plurality of qubit gates of a quantum circuit within a qubit frontier of a circuit operation of one or more qubit gates of the quantum circuit:
determining a set of three-qubit blocks from the qubit frontier to an interior of the circuit,
determining a number of operation of all blocks in the set of three-qubit blocks,
determining a family of blocks with a highest number of operations,
for each respective three-qubit block of the set of three-qubit blocks, find a best block family that starts with the respective three-qubit block and adheres to restriction zones of the blocks, and
adding a three-qubit block having a highest number of operations to an input block quantum circuit;
wherein each of the plurality of qubit gates is a one-bit or two-bit qubit gate.

20. The method of claim 11, further comprising interfacing with a quantum computer as the computer runs a program, and iterating the operations for different instructions than the quantum computer is executing.
